(19) United States
(12) Patent Application Publication
(10) Pub. No.: US 2023/0029200 A1
(43) Pub. Date: Jan. 26, 2023

(54) ACTIVELY COOLED END-PUMPED SOLID-STATE LASER GAIN MEDIUM

(71) Applicant: Coherent, Inc., Santa Clara, CA (US)

(72) Inventors: Qize SHU, San Jose, CA (US); Dmitri SIMANOVSKI, Palo Alto, CA (US)

(73) Assignee: Coherent, Inc., Santa Clara, CA (US)

(21) Appl. No.: 17/853,214

(22) Filed: Jun. 29, 2022

Related U.S. Application Data
(60) Provisional application No. 63/203,438, filed on Jul. 22, 2021.

(51) Int. Cl. H01S 3/042; H01S 3/0941; H01S 3/04; H05K 7/20

(52) U.S. Cl. CPC H01S 3/042; H01S 3/09415; H01S 3/0407; H05K 7/20272

(57) ABSTRACT

An actively cooled end-pumped solid-state laser gain device includes a bulk solid-state gain medium. An input-end of the gain medium receives a pump laser beam incident thereon and propagating in the direction toward an opposite output-end. The metal foil is disposed over a face of the gain medium extending between the input- and output-ends. A housing cooperates with the metal foil to form a coolant channel on the face the gain medium. The coolant channel has an inlet and an outlet configured to conduct a flow of coolant along the metal foil from the input-end towards the output-end. The metal foil is secured between the gain medium and portions of the housing running adjacent to the coolant channel. The metal foil provides a reliable thermal contact and imparts little or no stress on the bulk gain medium.

### PRIORITY

This application claims priority to U.S. Provisional Application Ser. No. 63/203,438, filed Jul. 22, 2021, the disclosure of which is incorporated herein by reference in their entirety.

### TECHNICAL FIELD OF THE INVENTION

The present invention relates in general to active liquid cooling of solid-state laser gain media in lasers and laser amplifiers. In particular, the present invention relates to active liquid cooling of a bulk solid-state laser gain medium that is subject to a significant, non-uniform heat load from a pump laser beam.

### DISCUSSION OF BACKGROUND ART

The gain medium of a solid-state laser or laser amplifier is a solid host-material doped with optically active ions capable of generating or amplifying laser radiation when excited. The host material is generally glass or crystalline, and the optically-active ions are typically rare earth or transition metal ions, such as neodynium, erbium, ytterbium, or titanium. The gain medium may be in the form of an optical fiber or a bulk crystal/glass. Most bulk gain media are shaped as a rod or a slab.

Commonly, solid-state laser gain media are optically pumped, that is, the optically active ions are optically excited to provide the needed population inversion for lasing action. Historically, the source of optical pumping was a flash lamp. At present, however, many solid-state laser gain media are pumped by laser radiation, since laser pumping tends to be more efficient than lamp pumping. Diode lasers are a particularly popular choice for the pump laser source due to their many advantages, e.g., efficiency, compactness, long lifetime, and low cost. Diode lasers may provide pump powers as high as hundreds of watts or even kilowatts. Some systems utilize arrays of laser diodes to provide the needed pump power.

In the case of diode-laser-pumped bulk gain media, several different pump geometries are possible. In end-pumping, the pump laser radiation is co-propagating (or, less commonly, counter-propagating) with the output laser radiation. Side-pumping entails directing the pump laser radiation into the gain medium, e.g., slab or rod, through a face that is parallel to the propagation direction of the output laser beam, such that the propagation direction of the pump laser radiation is generally perpendicular to that of the output laser radiation.

When the pump laser power is high, cooling of the bulk gain medium is necessary to limit adverse thermal effects resulting from absorption of the pump laser radiation. Without cooling, the temperature of the bulk gain medium will rise significantly and in a spatially non-uniform fashion. This temperature rise and non-uniform temperature distribution is associated with undesirable effects that may hamper the performance of the system. Some of these undesirable effects are related to thermal lensing. The thermal lens is primarily due to the thermo-optic effect, which is the temperature dependence of the refractive index of the gain medium, as well as thermal expansion of the gain medium. The thermal lens can be accommodated in the optical design of a laser. However, temperature dependences of the thermo-optic constant and the thermal conductivity cause aberrations in the thermal lens, which will ultimately limit the output power and degrade the beam quality of a laser. These aberrations are mitigated by minimizing the highest temperature inside the gain medium. In addition, the non-uniform temperature distribution causes non-uniform thermal expansion which, when combined with external mechanical pressure on the bulk gain medium, leads to mechanical stress in the gain medium. In worst case, the bulk gain medium may crack.

End-pumping is an advantageous geometry from a cooling perspective as the side surface(s) of the bulk gain medium may be in contact with cooling element(s) without interfering with the propagation paths of either one of the pump laser radiation and the output laser radiation. At high pump powers, however, end-pumping generates a thermal lens in the path of the laser radiation. This thermal lens tends to become increasingly aberrated with increasing temperature. While it is possible to operate a laser or laser amplifier with some degree of thermal lensing in the gain medium, it is preferable to keep the thermal lens relatively weak and, especially, prevent any significant aberration of the thermal lens.

Active water-cooling is an effective method for cooling the sides of a bulk gain medium. In one scheme, water is flowed along the side of the bulk gain medium in direct contact therewith. In another scheme, a copper block is placed in thermal contact with a side of the bulk gain medium to absorb heat therefrom while the copper block is cooled by flowing water. Indium is sometimes interposed between the copper block and the bulk gain medium. Indium, while being metallic and thus a thermal conductor, is relatively soft. As compared to copper, this softness allows indium to better conform to the surface of the gain medium, which is generally not perfectly smooth. The softness of indium also provides compliance to better maintain thermal contact between the gain medium and the copper block in the presence of dissimilar thermal expansion.

### SUMMARY OF THE INVENTION

Disclosed herein are solid-state laser gain devices based on a solid-state bulk gain medium that is actively cooled and configured for end-pumping. The disclosed laser gain devices are suitable for use in solid-state lasers as well as in solid-state laser amplifiers. At least one side surface of the bulk gain medium is in thermal contact with a metal foil that is actively cooled by a liquid coolant flow such as a water flow. The metal foil may be a copper foil. As compared to a solid metal block, e.g., a copper block, the flexibility of the present metal foil allows the metal foil to conform to the bulk gain medium to achieve a superior thermal contact between the coolant and the bulk gain medium. Particularly, the metal foil provides a more reliable thermal contact that is less susceptible to both (a) mechanical stress due to non-uniform thermal expansion of bulk gain medium and (b) variation in the assembly process. Furthermore, as compared to a solid metal block, the metal foil imparts less stress on the bulk gain medium.

In operation, the bulk gain medium is laser pumped in the end-pumping geometry, that is, with the pump beam incident on an input-end of the bulk gain medium and propagating in the direction toward an opposite output-end of the bulk gain medium. The coolant flows on the metal foil in the same direction, that is, in the direction from the input-end toward the output-end. This coordination of coolant flow direction with the pump beam propagation direction facilitates optimal cooling of the portion of the gain medium nearest the input-end and therefore subject to the greatest heat load from the pump beam.

In one aspect, an actively cooled end-pumped solid-state laser gain device includes a solid-state gain medium, a metal foil, and a housing. The solid-state gain medium has opposite first and second ends and a first face extending between the first and second ends. The first end is configured to receive a pump laser beam incident thereon and propagating in the direction toward the second end. The metal foil is disposed over the first face of the gain medium. The housing cooperates with the metal foil to form a coolant channel from the first end of the gain medium towards the second end of the gain medium. The coolant channel has an inlet and an outlet configured to conduct a flow of coolant along the metal foil from the first end towards the second end. The metal foil is secured between the gain medium and portions of the housing running adjacent to the coolant channel in a direction between the first and second ends.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates, in cross-sectional side view, an actively cooled end-pumped solid-state laser gain device with a slab-shaped, bulk solid-state gain medium and two active cooling elements, each configured to actively cool the gain medium with a liquid-cooled metal foil, according to an embodiment.

FIGS. 2A-C illustrate an exemplary spatial relationship between the gain medium of the device of FIG. 1 and either one of its cooling elements.

FIG. 3 is a cross-sectional side view of a portion of the FIG. 1 device showing how the coolant channel of each cooling element extends beyond the ends of the gain medium.

FIG. 4 is a cross-sectional side view of a portion of an alternative laser gain device with truncated coolant channels, according to an embodiment.

FIG. 5 is a cross-sectional end view of the laser gain devices of FIGS. 1 and 4.

FIG. 6 is a cross-sectional end view of an actively cooled end-pumped solid-state laser gain device based on a rod-shaped gain medium, according to an embodiment.

FIG. 7 illustrates a cooling element, wherein a metal foil is clamped against a housing to enclose and seal a coolant channel, according to an embodiment.

FIG. 8 illustrates, in cross-sectional side view, a cooling element for cooling the gain medium of either one of the laser gain devices of FIGS. 1 and 4, with enhanced cooling efficiency at the laser-pumped end of the gain medium, according to an embodiment.

### DETAILED DESCRIPTION OF THE INVENTION

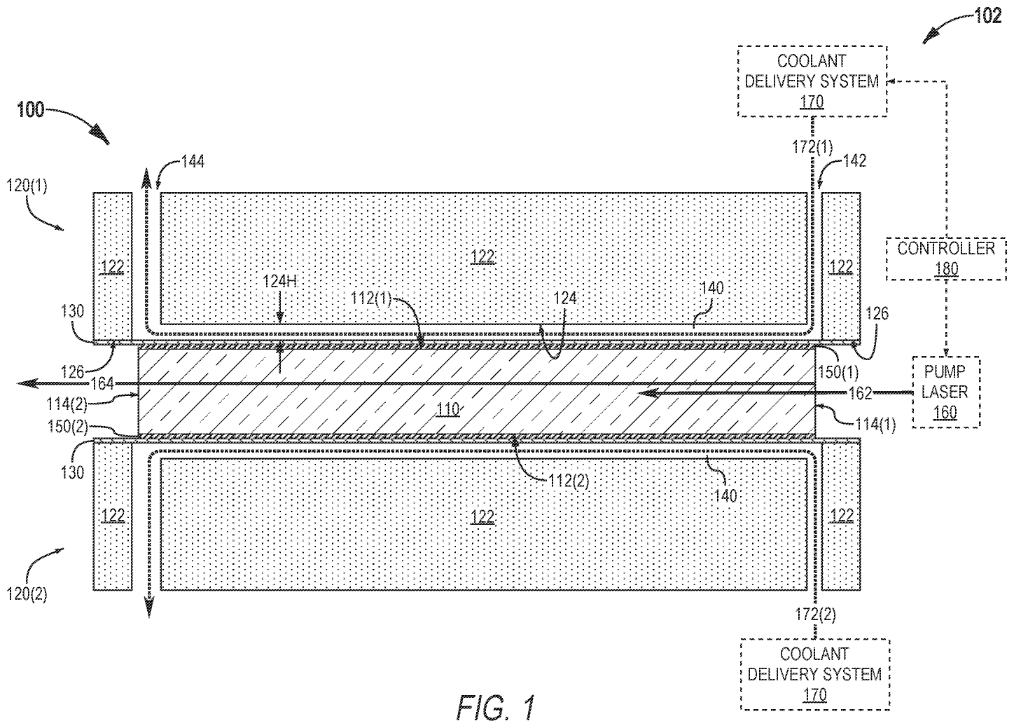

Referring now to the drawings, wherein like components are designated by like numerals, FIG. 1 is a cross-sectional side view of one actively cooled end-pumped solid-state laser gain device 100. Device 100 includes a bulk solid-state gain medium 110 and two active cooling elements 120(1,2) for cooling gain medium 110. Device 100 is configured for end-pumping by a pump laser beam 162. In operation, pump beam 162 is incident on an input-end 114(1) of gain medium 110 and propagates in the direction towards an opposite output-end 114(2) of gain medium 110.

In one use scenario, device 100 functions as a gain medium of a solid-state laser, in which case the population inversion in gain medium 110 generated by pump beam 162 leads to the generation of an output laser beam 164. Output beam 164 propagates collinearly with pump beam 162, either in the same direction as pump beam 162 or in the opposite direction. In another use scenario, device 100 functions as a gain medium of a solid-state laser amplifier, wherein the population inversion instead leads to amplification of a laser beam propagating through gain medium 110 collinearly with pump beam 162. In this scenario, output beam 164 is an amplified version of an input laser beam incident on one of ends 114.

Gain medium 110 is made of crystal, or glass, doped with optically active ions. Gain medium 110 is a slab with two opposite faces 112(1) and 112(2). Although not depicted in FIG. 1, gain medium 110 may include a coating on either one of faces 112(1) and 112(2). This coating may be a metal coating and, for example, include chromium, nickel, and/or gold. Cooling element 120(1) is disposed on face 112(1), and cooling element 120(2) is disposed on face 112(2). Each cooling element 120 is thermally coupled with gain medium 110 and serves to remove heat therefrom. In some instances, absorption of output beam 164 in gain medium 110 generates a non-negligible heat load. However, the heat load typically originates primarily from absorption of pump beam 162, specifically the quantum defect in lasing of the optically-active ions and any non-radiative losses thereof. As pump beam 162 propagates from input-end 114(1) of gain medium 110 towards output-end 114(2), absorption leads to a gradual attenuation of pump beam 162. Therefore, the heat load from pump beam 162 is greatest near input-end 114(1). The resulting temperature distribution in gain medium 110 is non-uniform, not only in the dimensions transverse to the propagation direction of pump beam 162, but also in the dimension along gain medium 110 from input-end 114(1) to output-end 114(2).

Each cooling element 120 includes a metal foil 130 and a housing 122. Metal foil 130 is disposed over a respective face 112 of gain medium 110. A surface 126 of housing 122 is coupled to metal foil 130, such that housing 122 forms a coolant channel 140 on metal foil 130. Coolant channel 140 has an inlet 142 and an outlet 144, and accommodates a coolant flow 172 from inlet 142 to outlet 144. Coolant flow 172 runs along metal foil 130 from input-end 114(1) at least partway to output-end 114(2). This direction of coolant flow 172 is preferable due to the greater heat load from pump beam 162 near input-end 114(1), as compared to output-end 114(2). The coolant may be pure water, an aqueous mixture, an aqueous solution, or a non-aqueous liquid.

The thickness of metal foil 130 may be less than 200 micrometers (μm), for example in the range between 50 and 100 μm. In one embodiment, metal foil 130 is made of copper, or a copper alloy, to conduct heat from gain medium 110 to coolant flow 172 with high efficiency. The copper (or copper alloy) foil may be plated with nickel and/or gold. In another embodiment, metal foil 130 is made of another metal with high thermal conductivity. For example, metal foil 130 may be made of, or include, nickel, silver, molybdenum, tantalum, and/or tungsten. As compared to a solid metal block, metal foil 130 is flexible and therefore conforms better to the surface of gain medium 110. In addition, when gain medium 110 and metal foil 130 undergo dissimilar thermal expansion or when gain medium 110 expands non-uniformly, metal foil 130 imparts little, if any, mechanical stress on gain medium 110. In contrast, a solid metal block is likely to impart stress on gain medium 110 in such scenarios. Stress on gain medium 110 may lead to birefringence in gain medium 110 and, as a result, polarization rotation or depolarization of output beam 164. Polarization changes typically cause loss and are undesirable.

Housing 122 may be made of stainless steel or another material that is relatively inert to the coolant flowing through coolant channel 140, e.g., plastic. Alternatively, housing 122 may be coated with an inert material.

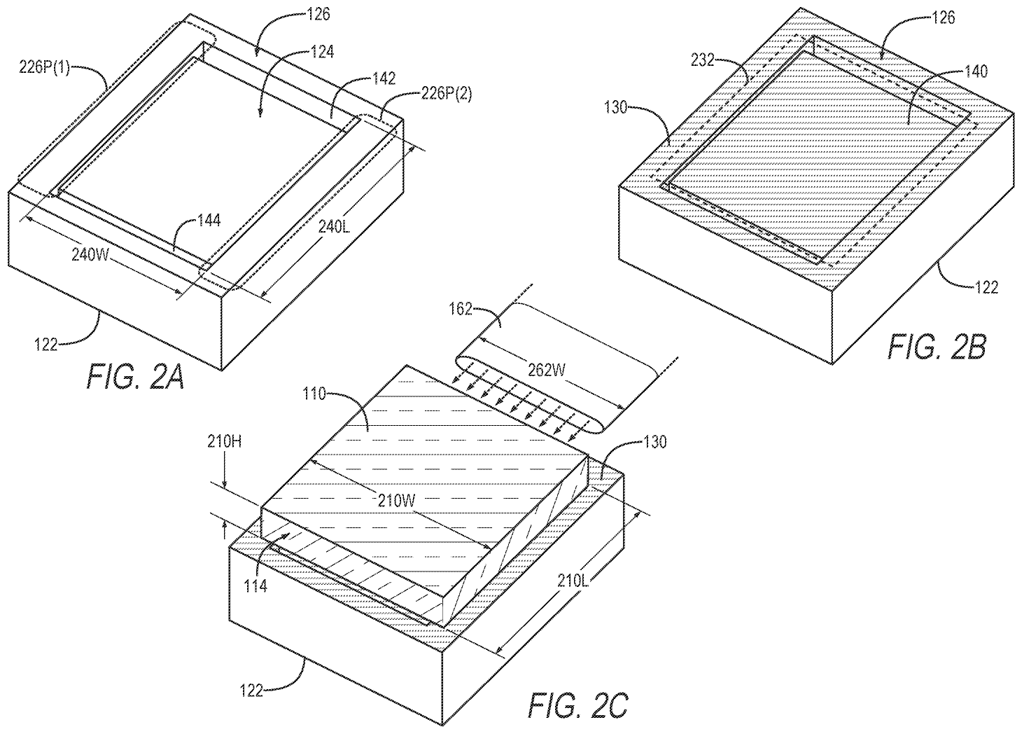

FIGS. 2A-C are a series of perspective views illustrating one exemplary spatial relationship between gain medium 110 and either one of cooling elements 120. FIG. 2A shows housing 122 with surface 126 facing up. Surface 126 surrounds a recessed surface 124 as well as channels that form inlet 142 and outlet 144. Surface 124 is also indicated in FIG. 1, and is on the opposite side of coolant channel 140 from face 112 of gain medium 110. As shown in FIG. 2B, metal foil 130 is located on surface 126, with the contact interface between metal foil 130 and surface 126 surrounding recessed surface 124, inlet 142, and outlet 144. Metal foil 130 is sealed to surface 126, such that coolant channel 140 is enclosed apart from the openings provided by inlet 142 and outlet 144. Surface 124 and metal foil 130 may be considered a floor and ceiling (or vice versa), respectively, of coolant channel 140. Metal foil 130 may be clamped and/or screwed to housing 122 to complete the seal to surface 126, optionally with a compliant seal therebetween. Alternatively, metal foil 130 may be soldered or brazed to surface 126.

Two portions 226P(1) and 226P(2) of surface 126, indicated in FIG. 2A, run adjacent to coolant channel 140 from inlet 142 to outlet 144. The associated portions of housing 122 form two respective walls on opposite sides of coolant channel 140. The width 210W of gain medium 110 exceeds the width 240W of coolant channel 140. Gain medium 110 is contacted to metal foil 130, with the contact interface between gain medium 110 and metal foil 130 extending onto each of surface portions 226P(1) and 226P(2), as shown in FIG. 2C. Metal foil 130 is thereby secured between (a) the corresponding face 112 of gain medium 110 and (b) surface portions 226P(1) and 226P(2). The contact between gain medium 110 and metal foil 130 may be direct, or indirect with one or more intervening layers disposed therebetween. The coupling between gain medium 110 and surface 126 locks the position of the otherwise floating gain medium 110 in device 100.

Referring now to FIGS. 1 and 2A-C in combination, gain medium 110 is positioned between cooling elements 120(1) and 120(2) in device 100. In certain embodiments, gain medium 110 is clamped in place between cooling elements 120(1) and 120(2). In such embodiments, surface 126 of each cooling element 120 exerts pressure on the portions of gain medium 110 within the footprint of gain medium 110 on surface 126.

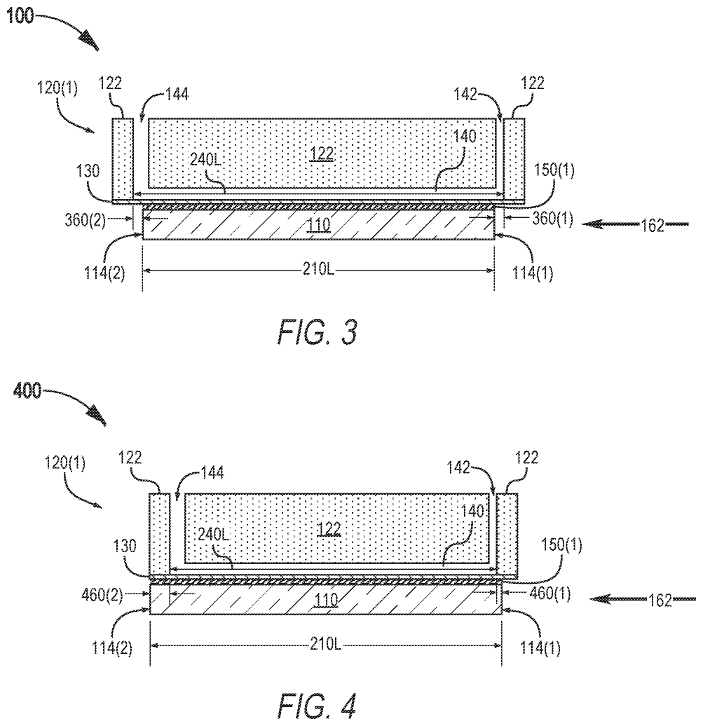

In the embodiments illustrated in FIGS. 1 and 2A-C, the length 210L of gain medium 110 is less than the length 240L of coolant channel 140 along metal foil 130 and surface 126. The associated footprint 232 of gain medium 110 on surface 126 and metal foil 130 is indicated in FIG. 2B. This relationship between the lengths of gain medium 110 and coolant channel 140 is illustrated in further detail in FIG. 3.

FIG. 3 is a partial, cross-sectional side view of a portion of device 100 showing only cooling element 120(1) and not cooling element 120(2). Cooling element 120(2) has similar properties to cooling element 120(1) in relation to gain medium 110 but is omitted from FIG. 3 for clarity of illustration. Length 240L of the segment of coolant channel 140 running along metal foil 130 and surface 126 exceeds length 210L of gain medium 110. Coolant channel 140 extends beyond input-end 114(1) by a distance 360(1) and beyond output-end 114(2) by a distance 360(2). Each of distances 360 may be in the range between 1 and 5 millimeters (mm). This configuration ensures active liquid cooling of the entire length of gain medium 110 between ends 114(1) and 114(2). Additionally, in embodiments where gain medium 110 is clamped between cooling elements 120(1) and 120(2), this configuration limits clamping pressure on gain medium 110 to the widthwise extreme portions thereof. Specifically, cooling elements 120(1) and 120(2) exert pressure only on the widthwise extreme portions of gain medium 110 overlapping with surface portions 226P(1) and 226P(2). As long as pump beam 162 is restricted to the portion of gain medium 110 that does not overlap with surface portions 226P(1) and 226P(2), cooling elements 120 are prevented from imparting external stress directly on the region of gain medium 110 conveying pump beam 162 and/or output beam 164. Such a scenario is depicted in FIG. 2C where the width 262W of the transverse 1/e² intensity profile of an exemplary pump beam 162 is within width 240W of coolant channel 140.

In alternative configurations, not depicted in FIGS. 1, 2A-C, and 3, length 240L of coolant channel 140 may match length 210L of gain medium 110 or even be inside one or both of ends 114. In particular, in the presence of strong attenuation of pump beam 162 in gain medium, it may be unnecessary to cool all the way to output-end 114(2). Additionally, although cooling is generally most needed in the region nearest input-end 114(1), practical considerations may favor that the segment of coolant channel 140 running along metal foil 130 starts slightly inside input-end 114(1), with little or no loss of cooling efficiency. This configuration could, however, result in an undesirable clamping pressure on the active region of gain medium 110.

FIG. 4 is a partial, cross-sectional side view of a portion of one laser gain device 400 having a truncated coolant channel 140. FIG. 4 utilizes the same view as FIG. 3. Device 400 is similar to device 100 except that coolant channel 140 is shortened at each of input-end 114(1) and output-end 114(2). Length 240L of the segment of coolant channel 140 running along metal foil 130 is less than length 210L of gain medium 110. The segment of coolant channel 140 running along metal foil 130 starts a distance 460(1) inside input-end 114(1) of gain medium 110, and ends a non-zero distance 460(2) before output-end 114(2) of gain medium 110. Distance 460(1) may be in the range between zero and 2 mm. Distance 460(2) may be in the range between 1 mm and 25% of length 210L of gain medium 110.

In each of devices 100 and 400, the dimensions of gain medium 110 may be tailored as needed (dimensions are indicated in FIG. 2C). Usually, length 210L exceeds height 210H of gain medium 110. In one embodiment, width 210W also exceeds height 210H, by as much as up to a factor of five, ten, or more. Such embodiments are compatible with a highly elongated pump beam 162, as illustrated in FIG. 2C, for example as generated by a laser diode bar. Such embodiments may also be operated with a pump beam 162 characterized by width 262W being less than width 210W, as shown in FIG. 2C, to contain pump beam 162 and output beam 164 within a region of gain medium 110 not subject to pressure from housing 122. In one example, height 210H is in the range between 0.5 and 5 mm, width 210W is in the range between 2 and 20 mm, and length 210L is in the range between 5 and 20 mm.

As indicated in FIGS. 1, 3, and 4, certain embodiments of each of devices 100 and 400 further include an indium layer 150 between metal foil 130 of each cooling element 120 and the corresponding face 112 of gain medium 110. Indium layer 150 serves to improve the thermal contact between metal foil 130 and the corresponding face 112 of gain medium 110. Indium layer 150 may be soldered in place between metal foil 130 and gain medium 110 to ensure good contact between gain medium 110 and metal foil 130 via indium layer 150. Soldering of indium layer 150 may be achieved by heating device 100 to a temperature that exceeds the 157° C. melting temperature of indium. Alternatively, indium layer 150 may be held in place between metal foil 130 and surface 126 of housing 122. In this case, the pressure of coolant flow 172 may aid thermal contact between gain medium 110 and surface 126 via indium layer 150. Indium layer 150 may be incorporated into device 100/400 in the form of a sheet or a foil. In one embodiment, the thickness of indium layer 150 is in the range between 50 and 500 μm.

Each one of devices 100 and 400 may be implemented in a laser gain system that, in addition to device 100/400, includes a pump laser 160 and a coolant delivery system 170. FIG. 1 schematically illustrates such a laser gain system 102 based on device 100. Pump laser 160 generates pump beam 162. Pump laser 160 may be based on a variety of laser technologies. In one example, pump laser 160 uses one or more laser diodes to generate pump beam 162. Due to their efficiency, affordability, reliability, and ease of use, laser diodes are often a preferred pump laser source. Coolant delivery system 170 may include one or more fluid pumps, and is coupled to housing 122 of each cooling element 120 to generate coolant flow 172 through coolant channel 140. System 102 may further include a controller 180 that governs the operation of pump laser 160 and/or coolant delivery system 170.

Devices 100 and 400 may be modified to include only one of cooling elements 120. In such embodiments, the omitted cooling element 120 may be replaced by a fixture, for example for supporting gain medium 110. Gain medium 110 may be clamped in place between this fixture and the remaining cooling element 120.

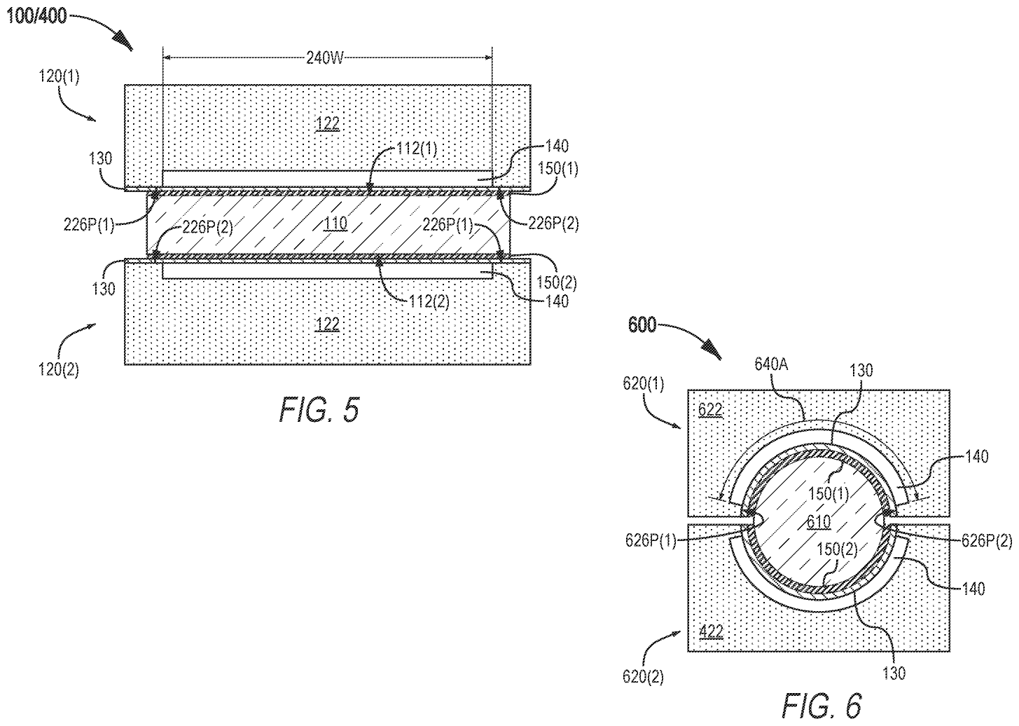

FIG. 5 is a cross-sectional end view of device 100/400, with the cross section intersecting slab-shaped gain medium 110 and coolant channel 140 of each cooling element 120. This cross-sectional end view is orthogonal to the cross-sectional side views of device 100 in FIGS. 1 and 3 and device 400 in FIG. 4. In each cooling element 120, metal foil 130 is sealed to housing 122 to close coolant channel 140, and the footprint of gain medium 110 overlaps with surface portions 226P(1) and 226P(2) of each cooling element 120. Coolant channel 140 of each cooling element 120 spans width 240W across a portion of gain medium 110.

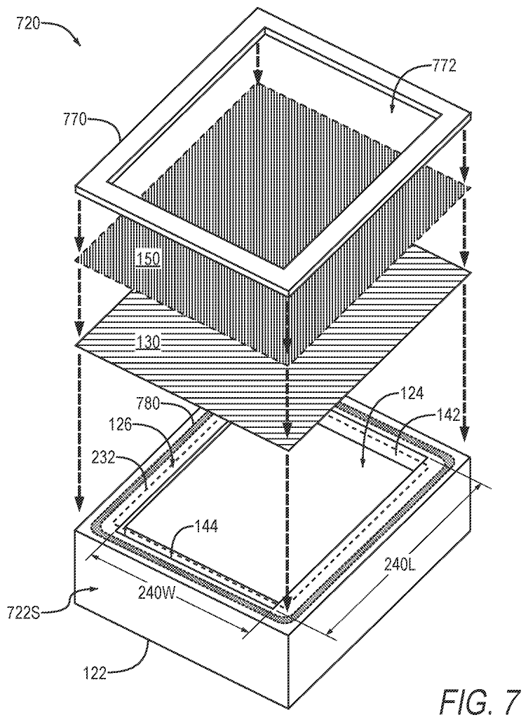

While gain medium 110 is in the form of a slab, devices 100 and 400 are readily modifiable to accommodate end-pumped gain media of other shapes, for example a rod-shaped gain medium. FIG. 6 illustrates one exemplary modification of device 100/400 from implementing a slab-shaped gain medium to implementing a rod-shaped gain medium.

FIG. 6 is a cross-sectional end view of an actively cooled end-pumped solid-state laser gain device 600 based on a rod-shaped gain medium 610. Device 600 is a modification of either one of devices 100 and 400 adapted to accommodate rod-shaped gain medium 610. Here, the rod has a circular cross-sectional shape. However, the rod could have a square shape or other polygonal shapes. Device 600 includes one or two cooling elements 620. When including two cooling elements 620(1) and 620(2), these cooling elements may be disposed on opposite faces of gain medium 610 as shown in FIG. 6. (When gain medium 610 is a rod with a circular cross-sectional shape, these two faces are opposite sides of the cylindrical outer surface of gain medium 610.) Each cooling element 620 is an adaptation of cooling element 120 that fits the curved faces of gain medium 610.

Each cooling element 620 includes metal foil 130 and a housing 622. Metal foil 130 is wrapped around a portion of gain medium 610. Housing 622 and metal foil 130 cooperatively form coolant channel 140 around the circumference of gain medium 610. Metal foil 130 is secured between gain medium 610 and surface portions 626P(1) and 626P(2) located adjacent coolant channel 140. Whereas coolant channel 140 of device 100/400 spans a linear width 240W, coolant channel 140 of device 600 has an angular span 640A. In the embodiment depicted in FIG. 6, angular span 640A is less than 180 degrees, for example in the range between 90 and 170 degrees. This angular span 640A enables clamping of gain medium 610 between two cooling elements 620(1) and 620(2), or between one cooling element 620 and a fixture replacing the other cooling element 620.

In embodiments of device 600 that include both of cooling elements 620(1) and 620(2), cooling elements 620(1) and 620(2) may utilize a common metal foil 130 rather than two separate metal foils 130. Device 600 may include indium layer 150 between gain medium 610 and metal foil 130 of each cooling element 620, in a manner similar to that discussed above for device 100.

The remainder of this disclosure will be based on a slab-shaped gain medium. However, in a manner similar to the adaptation of the FIG. 5 configuration to arrive at the FIG. 6 configuration, the embodiments disclosed below are readily extended to other gain-medium shapes, such as a rod-shaped gain medium.

FIG. 7 is an exploded view of one cooling element 720, wherein metal foil 130 is clamped against housing 122 to enclose and seal coolant channel 140 (apart from inlet 142 and outlet 144). Cooling element 720 is an embodiment of cooling element 120 and may be implemented in either one of devices 100 and 400. FIG. 7 shows parts in a perspective view similar to that used in FIGS. 2A-C. Cooling element 720 includes housing 122, metal foil 130, a bracket 770, and, optionally, indium layer 150. The thick dashed arrows in FIG. 7 indicate how parts of cooling element 720 spatially come together when assembled. Bracket 770 is clamped against surface 126 of housing 122, with metal foil 130 disposed between bracket 770 and surface 126. Bracket 770 forms an aperture 772 sized to contain the footprint 232 of gain medium 110. Once cooling element 720 is assembled, gain medium 110 may be disposed on cooling element 720 inside aperture 772.

Indium layer 150 may be integrated in cooling element 720. In one such implementation, indium layer 150 is clamped between metal foil 130 and bracket 770.

Many different options exist for affixing bracket 770 to housing 122. In one embodiment, bracket 770 is screwed or otherwise clamped onto surface 126. In another embodiment, bracket 770 extends beyond surface 126, and at least a portion of bracket 770 is affixed to other surfaces of housing 122, such as an end surface 722S. For example, bracket 770 may be screwed to portions of surface 126 running along the lengthwise dimension of coolant channel 140 parallel to length 240L, and wrap down along end surface 722S (and a similar opposite end surface of housing 122) to be affixed thereto. This example is advantageous for minimizing the bulk of bracket 770 at ends 114 of gain medium 110 where laser beams enter and exit gain medium 110. Housing 122 may have additional features, not shown in FIG. 7, to facilitate mounting of bracket 770 to other portions of housing 122 than surface 126.

In one embodiment, cooling element 720 includes a compliant seal 780, such as a rubber gasket (e.g., an O-ring), between metal foil 130 and surface 126. Compliant seal 780 surrounds recessed surface 124, inlet 142, and outlet 144, and may help ensure a tight seal between metal foil 130 and surface 126. Although not shown in FIG. 7, compliant seal 780 may be seated in a groove in surface 126.

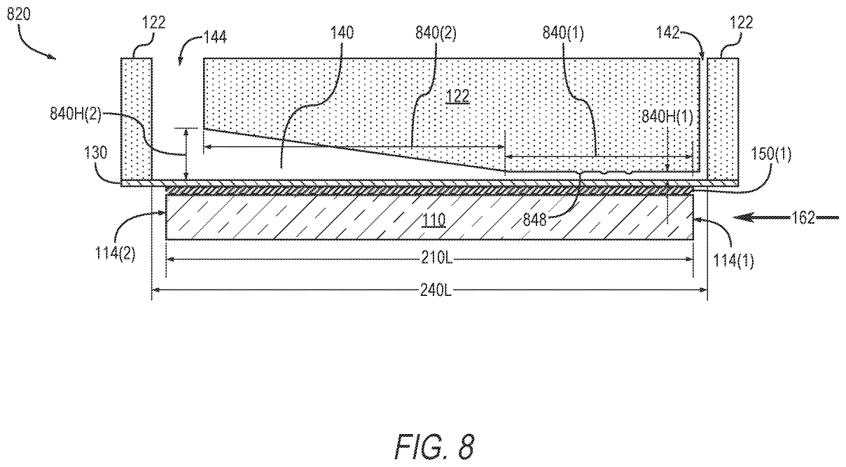

FIG. 8 illustrates one cooling element 820 for cooling gain medium 110 with enhanced cooling efficiency at input-end 114(1) as compared to output-end 114(2). Cooling element 820 is an embodiment of cooling element 120 and may be implemented in either one of devices 100 and 400, and with length 240L of coolant channel 140 being longer, shorter, or the same as length 210L of gain medium 210.

Coolant channel 140 of cooling element 820 has a non-uniform height 840H to impose a non-uniform coolant flow speed along the lengthwise dimension of gain medium 110. Specifically, the height of coolant channel 140 near input-end 114(1) is less than the height of coolant channel 140 near output-end 114(2), such that the speed of coolant flow 172 (see FIG. 1) is greater at input-end 114(1) than at output-end 114(2). This height variation of coolant channel 140 serves to maximize the cooling efficiency at the region of gain medium 110 nearest input-end 114(1), subject to the greatest heat load from pump beam 162, while reducing the coolant flow impedance in a downstream portion of coolant channel 140 adjacent a portion of gain medium 110 that is subject to a lesser heat load from pump beam 162. Cooling element 820 thereby provides efficient cooling where most needed, while reducing the coolant pressure drop between inlet 142 and outlet 144. The pressure drop determines the size, power, and cost of the fluid pump used to achieve a particular flow rate, and it is therefore advantageous to avoid a very large pressure drop. In the embodiment depicted in FIG. 8, coolant channel 140 has a relatively shallow height 840H(1) through a first segment of length 840(1) from input-end 114(1), and then an increasing height in a subsequent segment of length 840(2) until reaching a height 840H(2) at outlet 144. The height increase through this subsequent segment of coolant channel 140 may be gradual, as shown in FIG. 8, or step-wise. Length 840(1) may be comparable to or exceed the 1/e absorption length of pump beam 162 in gain medium 110.

In an alternative embodiment, a relatively shallow height 840H(1), needed to achieve sufficient cooling near input-end 114(1), is maintained along the entire length of coolant channel 140. In this embodiment, the pressure drop along coolant channel may be too great to maintain the desired coolant flow speed near input-end 114(1). This potential issue is prevented in cooling element 820 by increasing the height of coolant channel 140 after the initial shallow segment near input-end 114(1).

In one example, height 840H(1) is less than 1 mm, for example in the range between 0.1 and 1 mm. Height 840H(2) may be in the range between 1 and 5 mm. In one implementation, the height of coolant channel 140 along length 840(2) is inversely proportional to the local heat load in gain medium 110.

Due to height 840H(1) being relatively shallow, coolant flow 172 through this first segment of coolant channel 140, characterized by having height 840H(1), may be laminar. The cooling efficiency through this first segment of coolant channel 140 may be improved by incorporating protruding and/or recessed features 848 to introduce turbulence. In one implementation, protruding features 848 are implemented in the surface of housing 122 facing gain medium 110, as shown in FIG. 8. Positioning of features 848 on housing 122 is typically preferred over positioning of features 848 on metal foil 130 at least because (a) it is more practical to manufacture such features in the material of housing 122 than in metal foil 130 and (b) uniform thickness of metal foil 130 likely ensures more consistent thermal conductivity between gain medium 110 and coolant flow 172.

The performance of cooling element 820, with indium layer 150, was evaluated experimentally and compared to the performance of a conventional solid copper block also implementing an indium layer. An end-pumped, slab-shaped gain medium was cooled from two sides by two respective conventional water-cooled solid copper blocks. With an optical pump power of approximately 220 watts, the conventional solid copper blocks maintained a gain-medium temperature of approximately 100° C. When the same gain medium was implemented in device 100 and cooled by two cooling elements 820, it was possible to pump the gain medium with a higher pump power, approximately 250 watts, and yet maintain a lower gain-medium temperature of approximately 70° C.

Without departing from the scope hereof, any one of the laser gain devices disclosed above may be operated with a coolant flow propagating in the direction opposite to the propagation direction of pump beam 162, that is, with the coolant entering coolant channel 140 via outlet 144 and exiting via inlet 142. At least when the 1/e absorption length of pump beam 162 in gain medium 110 is less than length 210L of gain medium 110, the cooling performance of this counter-propagating coolant flow is likely inferior to that of the co-propagating coolant flow discussed above. However, even with a counter-propagating coolant flow, the laser gain devices still benefit from other advantages, such as excellent and reliable thermal contact between gain medium 110 and the coolant, as well as minimal mechanical stress on gain medium 110.

The present invention is described above in terms of a preferred embodiment and other embodiments. The invention is not limited, however, to the embodiments described and depicted herein. Rather, the invention is limited only by the claims appended hereto.

What is claimed is:

1. An actively cooled end-pumped solid-state laser gain device, comprising:
a solid-state gain medium having opposite first and second ends and a first face extending between the first and second ends, the first end being configured to receive a pump laser beam incident thereon and propagating in the direction toward the second end;
a metal foil disposed over the first face of the gain medium; and
a housing that cooperates with the metal foil to form a coolant channel from the first end of the gain medium towards the second end of the gain medium, the coolant channel having an inlet and an outlet configured to conduct a flow of coolant along the metal foil from the first end towards the second end;
wherein the metal foil is secured between the gain medium and portions of the housing running adjacent to the coolant channel in a direction between the first and second ends.

2. The device of claim 1, wherein:
the metal foil is clamped onto the housing to form a cooling element therewith; and
the laser further comprises a fixture disposed on a second face of the gain medium opposite the first face, the gain medium being clamped between the cooling element and the fixture.

3. The device of claim 2, wherein the fixture is a second instance of the cooling element with its metal foil disposed over the second face of the gain medium to provide cooling of the gain medium via the second face

4. The device of claim 1, further comprising an indium layer between the metal foil and the first face of the gain medium.

5. The device of claim 4, wherein the indium layer is soldered between the metal foil and the first face of the gain medium.

6. The device of claim 4, wherein the thickness of the indium layer is in the range between 50 and 500 micrometers.

7. The device of claim 1, wherein the metal foil is secured between the first face of the gain medium and two walls of the housing, each of the two walls extending between the first and second ends of the gain medium on a respective side of the coolant channel.

8. The device of claim 1, wherein the metal foil is coupled to the portions of the housing via a compliant seal.

9. The device of claim 1, wherein the metal foil is soldered or brazed to the housing.

10. The device of claim 1, wherein the metal foil includes copper.

11. The device of claim 1, wherein the thickness of the metal foil is between 50 and 200 micrometers.

12. The device of claim 1, wherein height of the coolant channel above the metal foil is less at the first end than at a location closer to the second end, such that the speed of flow of the coolant is greater at the first end than at the location closer to the second end.

13. The device of claim 12, wherein the height of the coolant channel is less than 1 millimeter through a first segment of the coolant channel nearest the first end.

14. The device of claim 13, wherein the first segment spans from the first end to a location that is spaced apart from the first end by at least the 1/e absorption length of the pump laser beam in the gain medium.

15. The device of claim 13, wherein the height of the coolant channel in a second segment, extending from the first segment at least partway to the second end, increases as a function of distance from the first end.

16. The device of claim 13, wherein a surface of the housing, facing the metal foil and forming a ceiling of the first segment of the coolant channel, has recessed or protruding features to induce turbulence in the flow of the coolant.

17. The device of claim 1, wherein the coolant channel extends at least the length of the gain medium from the first end to the second end.

18. The device of claim 1, wherein the metal foil and the coolant channel extend beyond the first and second ends in a dimension parallel to the first face of the gain medium.

19. The device of claim 1, wherein the gain medium has a length L from the first end to the second end, and the portion of the metal foil sandwiched between the gain medium and the coolant channel extends from a location that is within 1 millimeter of the first end to a location that is within 0.25 L of the second end.

20. A laser gain system, comprising:
the device of claim 1;
a pump laser for generating the pump laser beam; and
a coolant delivery system for pumping the coolant into the coolant channel via the inlet.
